(19) United States
(12) Patent Application Publication
(10) Pub. No.: US 2015/0290975 A1
(43) Pub. Date: Oct. 15, 2015

(54) PNEUMATIC TIRE WITH AN INNER LINER BONDED BY A FIBRE ASSEMBLY

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Emmanuel Custodero, Clermont-Ferrand (FR); Marc Greiveldinger, Clermont-Ferrand (FR); Vincent Lemal, Clermont-Ferrand (FR)

(21) Appl. No.: 14/443,254

(22) PCT Filed: Nov. 7, 2013
(86) PCT No.: PCT/EP2013/073235

§ 371 Date: May 15, 2015

(30) Foreign Application Priority Data
Nov. 15, 2012 (FR) 1260868

(51) Int. Cl. B60C 5/14; B29D 30/06; B60C 1/00

(52) U.S. Cl. CPC B60C 5/14; B60C 1/0008; B29D 30/06

(57) ABSTRACT

A pneumatic tire comprises an outer rubber tread, a carcass reinforcement, a gastight layer positioned internally relative to the carcass reinforcement and an adhesion layer adjacent to the gastight layer and positioned between the carcass reinforcement and the gastight layer. The adhesion layer consists of a deformable fibre assembly.

### FIELD OF THE INVENTION

The present invention relates to the field of pneumatic tyres, and relates more particularly to the gastight layers that ensure that these pneumatic tyres are airtight.

### PRIOR ART

In a conventional pneumatic tyre of the “tubeless” type (that is to say of the type without an inner tube), the radially internal face comprises an airtight layer (or more generally a layer gastight to any inflation gas) which makes it possible to inflate the pneumatic tyre and to keep it under pressure. Its airtightness properties allow it to guarantee a relatively low level of pressure loss, making it possible to keep the tyre inflated in a normal operating state for a sufficient period of time, normally of several weeks or several months. Another role of this layer is to protect the materials of the internal structure of the pneumatic tyre from the diffusion of air originating from the space interior to the tyre.

This role of airtight inner layer or “inner liner” is today fulfilled by compositions based on butyl rubber (copolymer of isobutylene and isoprene), which have been recognized for a very long time for their excellent airtightness properties.

However, a well-known disadvantage of compositions based on butyl rubber or elastomer is that they exhibit high hysteresis losses, furthermore over a broad temperature spectrum, which disadvantage is damaging to the rolling resistance of the pneumatic tyres.

To reduce the hysteresis of these airtight inner layers and thus, in the end, the fuel consumption of motor vehicles is a general objective which current airtight sealing technology comes up against.

Document WO 2008/145277 by the Applicant companies discloses a pneumatic article provided with a layer airtight to the inflation gases, in which the airtight layer comprises an elastomer composition comprising at least a thermoplastic elastomer having polystyrene and polyisobutylene blocks, and a polybutene oil.

Compared with butyl rubber, the thermoplastic elastomer has the major advantages, due to its thermoplastic nature, of being able to be worked as is in the melt (liquid) state and consequently of offering a possibility of simplified processing, and also of reducing the rolling resistance of the pneumatic tyre. On the other hand, the use of these gastight layers is limited by the absence of bonds created during the vulcanization of the pneumatic tyre with the adjacent rubber compounds.

In order to solve this problem, document WO 2010/063427 A1 discloses a pneumatic tyre comprising a crown with an outer rubber tread and a crown reinforcement, a carcass reinforcement, a gastight layer positioned internally relative to the carcass reinforcement and an adhesion layer adjacent to the gastight layer and positioned between the carcass reinforcement and the gastight layer, in which the gastight layer is a composition based on a thermoplastic elastomer having polystyrene and polyisobutylene blocks and the adhesion layer is a composition based on an unsaturated thermoplastic elastomer having polystyrene and polydiene blocks.

This adhesion layer is intended to reinforce the adhesion between the thermoplastic elastomer layer and a diene elastomer layer such as a calendering of carcass ply based on natural rubber usually used in pneumatic tyres.

### BRIEF DESCRIPTION OF THE INVENTION

A subject of the invention is a similar pneumatic tyre in which the adhesion layer consists of a deformable fibre assembly.

The Applicant companies have observed very surprisingly that this deformable fibre assembly, when it is positioned in the uncured state between the airtight layer and for example the calendering of the carcass reinforcement ensures, after curing at high temperature and under pressure, a good adhesion of the airtight layer to the calendering of the pneumatic tyre.

This deformable fibre assembly furthermore has the advantage of substantially improving the airtightness performance of the pneumatic tyre.

The presence of such a deformable fibre assembly impregnated during the pressurized curing of the pneumatic tyre by the elastomer materials of the airtight layer on the one hand and of the adjacent rubber liner on the other hand makes it possible to obtain a sufficient cohesion of the airtight layer with the adjacent rubber liner.

The gastight layer may advantageously be based on a thermoplastic elastomer containing a polyisobutylene block and a thermoplastic block (TPEI elastomer).

Very advantageously, the gastight layer may be based on a thermoplastic elastomer containing a polyisobutylene block and a polystyrene block.

The cohesion resulting from the presence of the deformable fibre assembly thus makes it possible to more easily use such thermoplastic elastomers having polyisobutylene blocks as main constituent of the gastight layers.

According to another embodiment, the gastight layer may be based on a butyl rubber.

Another subject of the invention is a process for manufacturing a pneumatic tyre comprising a gastight layer, in which an adhesion layer is incorporated into said pneumatic tyre during the manufacture thereof, characterized in that an adhesion layer consisting of a deformable fibre assembly is positioned on the radially outer surface of said gastight layer.

According to a first embodiment, after having deposited said gastight layer flat on a tyre-building drum, said adhesion layer is placed on this drum.

According to an alternative embodiment, before depositing said gastight layer flat on a tyre-building drum, a deformable fibre assembly is deposited on said gastight layer in order to form a laminate.

The invention relates particularly to the pneumatic tyres intended to be fitted on motor vehicles of the passenger type, SUV (“Sport Utility Vehicle”) type, two-wheeled vehicles (in particular motorcycles), aircraft and industrial vehicles selected from vans, heavy-duty vehicles—i.e. underground trains, buses, heavy road transport vehicles (lorries, tractors, trailers), off-road vehicles such as agricultural or civil engineering vehicles, and other transport or handling vehicles.

### I. DETAILED DESCRIPTION OF THE INVENTION

In the present description, unless expressly indicated otherwise, all the percentages (%) indicated are % by weight.

Moreover, any interval of values denoted by the expression “between a and b” represents the range of values extending from more than a to less than b (i.e. limits a and b excluded) whereas any interval of values denoted by the expression “from a to b” signifies the range of values extending from a up to b (i.e. including the strict limits a and b).

As is common, either of the terms “elastomer” and “rubber”, which are interchangeable, are used in the text.

### I-1. Gastight Layer

### I-1-A. Airtight Layer Based on Butyl Rubber

Butyl rubber is commonly understood to mean a homopolymer of isobutylene or a copolymer of isobutylene with isoprene (this butyl rubber belongs to diene elastomers), and also the halogenated, in particular generally brominated or chlorinated, derivatives of these homopolymers and copolymers of isobutylene and isoprene.

Mention will be made, as examples of butyl rubber commonly used as constituent of inner liners, of: copolymers of isobutylene and isoprene (IIR), bromobutyl rubbers such as the bromo-isobutylene-isoprene copolymer (BIIR) and chlorobutyl rubbers such as the chloro-isobutylene-isoprene copolymer (CIIR).

By extension of the preceding definition, copolymers of isobutylene and styrene derivatives such as the brominated isobutylene and methylstyrene copolymers (BIMS) to which in particular the elastomer named EXXPRO sold by Exxon belongs, will also be included under the name “butyl rubber”.

Applications WO 2006/047509 and WO 2008/145314 present examples of the use of such butyl rubbers for producing inner liners of pneumatic tyres and also formulation examples of such inner liners.

The adhesion layer according to one subject of the invention may be used to reinforce the adhesion to the rest of the structure of the pneumatic tyre of all the airtight layers based on butyl rubber, whether this rubber is the only elastomer of the airtight layer or the predominant elastomer thereof.

### I-1-B. Airtight Layer Based on a Thermoplastic Elastomer Containing a Polyisobutylene Block

I.1.B.1 Thermoplastic Elastomer Containing a Polyisobutylene Block

Thermoplastic elastomers containing a polyisobutylene block (hereinafter abbreviated to “TPEI”) have a structure intermediate between thermoplastic polymers and elastomers. They are composed of rigid thermoplastic sequences connected via flexible polyisobutylene elastomer sequences. These TPEI may for example be diblock copolymers, comprising a thermoplastic block and an elastomer block, here a polyisobutylene block. They are often triblock elastomers with two rigid segments connected via a flexible segment. The rigid and flexible segments may be arranged linearly, in star fashion or branched fashion. Typically, each of these segments or blocks contains at least more than 5, generally more than 10, base units.

The number-average molecular weight (denoted by Mₙ) of the thermoplastic elastomer containing a polyisobutylene block is preferably between 30 000 and 500 000 g/mol, more preferably between 40 000 and 400 000 g/mol. Below the minima indicated, there is a risk of the cohesion between the chains of the TPEI being affected, in particular due to its possible dilution (in the presence of an extender oil); moreover, an increase in the operating temperature risks affecting the mechanical properties, in particular the properties at break, with a consequence of a reduced performance “under hot conditions”. Furthermore, an excessively high Mₙ weight may be damaging with regard to the flexibility of the gastight layer. Thus, it has been found that a value within a range from 50 000 to 300 000 g/mol is particularly well suited, in particular to use of the thermoplastic elastomer containing a polyisobutylene block or TPEI in a pneumatic tyre composition.

The number-average molecular weight (Mₙ) of the TPEI is determined in a known way by size exclusion chromatography (SEC). The sample is dissolved beforehand in tetrahydrofuran at a concentration of approximately 1 g/l; the solution is then filtered through a filter with a porosity of 0.45 μm before injection. The equipment used is a “Waters alliance” chromatographic chain. The elution solvent is tetrahydrofuran, the flow rate is 0.7 ml/min, the temperature of the system is 35° C. and the analysis time is 90 min. A set of four Waters columns in series, with “Styragel” trade names (“HMW7”, “HMW6E” and two “HT6E”), is used. The injected volume of the solution of the polymer sample is 100 μl. The detector is a “Waters 2410” differential refractometer and its associated software for handling the chromatographic data is the “Waters Millenium” system. The calculated average molecular weights are relative to a calibration curve produced with polystyrene standards.

The polydispersity index Iₚ (it should be remembered that Iₚ=M_{w}/Mₙ with M_{w} the weight-average molecular weight) of the TPEI is preferably less than 3; more preferably Iₚ is less than 2 and more preferably still less than 1.5.

The elastomer block is composed predominantly of the polymerized isobutylene monomer. Preferably, the polyisobutylene block of the block copolymer has a number-average molecular weight (“Mₙ”) ranging from 25 000 g/mol to 350 000 g/mol, preferably from 35 000 g/mol to 250 000 g/mol, so as to confer, on the thermoplastic elastomer, good elastomeric properties and a mechanical strength which is sufficient and compatible with the pneumatic tyre inner liner application.

Preferably, the polyisobutylene block of the block copolymer additionally has a glass transition temperature (“T_{g}”) of less than or equal to −20° C., more preferably of less than −40° C. A T_{g} value greater than these minima may reduce the performance of the airtight layer during use at very low temperature; for such a use, the T_{g} of the polyisobutylene block of the block copolymer is more preferably still less than −50° C.

The polyisobutylene block of the TPEI may also advantageously comprise a content of units resulting from one or more conjugated dienes inserted into the polymer chain preferably ranging up to 16% by weight relative to the weight of the polyisobutylene block. Above 16%, a fall in the resistance to thermal oxidation and to oxidation by ozone may be observed for the airtight layer comprising the thermoplastic elastomer containing a polyisobutylene block used in a tyre.

The conjugated dienes which may be copolymerized with the isobutylene in order to form the polyisobutylene block are conjugated C₄-C₁₄ dienes. Preferably, these conjugated dienes are selected from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is isoprene or a mixture containing isoprene.

The polyisobutylene block, according to an advantageous aspect of a subject of the invention, may be halogenated and may comprise halogen atoms in its chain. This halogenation makes it possible to improve the compatibility of the airtight layer with the other adjacent constituent components of a pneumatic tyre. The halogenation is carried out by means of bromine or chlorine, preferably bromine, on the units resulting from conjugated dienes of the polymer chain of the polyisobutylene block. Only a portion of these units reacts with the halogen.

Use will be made, for the definition of the thermoplastic blocks, of the characteristic of glass transition temperature (T_{g}) of the rigid thermoplastic block. This characteristic is well known to a person skilled in the art. It makes it possible in particular to select the industrial processing (transformation) temperature. In the case of an amorphous polymer (or polymer block), the processing temperature is selected to be substantially greater than the T_{g} of the thermoplastic block. In the specific case of a semicrystalline polymer (or polymer block), a melting point may be observed which is then greater than the glass transition temperature. In this case, it is instead the melting point (MP) which makes it possible to select the processing temperature of the polymer (or polymer block) under consideration. Thus, subsequently, when reference is made to “T_{g} (or MP, where appropriate)”, it should be considered that this is the temperature used for selecting the processing temperature.

Preferably, the thermoplastic elastomer containing a polyisobutylene block according to one subject of the invention comprises, at at least one of the ends of the polyisobutylene block, a thermoplastic block, the glass transition temperature (or melting point, where appropriate) of which is greater than or equal to 100° C.

According to a first embodiment, the TPEI is selected from styrene thermoplastic elastomers containing a polyisobutylene block (“TPSI”).

The styrene thermoplastic block thus consists of at least one polymerized monomer based on unsubstituted or substituted styrene; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or para-hydroxystyrene.

Preferably, the TPSI thermoplastic elastomer contains polystyrene and polyisobutylene blocks.

Preferably, such a TPSI is a styrene/isobutylene diblock elastomer (abbreviated to “SIB”).

More preferably still, such a TPSI is a styrene/isobutylene/styrene triblock elastomer (abbreviated to “SIBS”).

According to a preferred embodiment of the invention, the weight content of styrene (unsubstituted or substituted) in the styrene elastomer is between 5% and 50%. Below the minimum indicated, the thermoplastic nature of the elastomer risks being substantially reduced, whereas, above the recommended maximum, the elasticity of the airtight layer may be affected. For these reasons, the styrene content is more preferably between 10% and 40%, in particular between 15% and 35%.

The TPSI elastomers may be processed conventionally, by extrusion or moulding, for example starting from a raw material available in the form of beads or granules.

The TPSI elastomers are available commercially, for example sold, as regards the SIB and SIBS, by Kaneka under the name “Sibstar” (e.g. “Sibstar 103T”, “Sibstar 102T”, “Sibstar 073T” or “Sibstar 072T” for the SIBSs or “Sibstar 042D” for the SIBs). They have, for example, been described, along with their synthesis, in the patent documents EP 731 112, U.S. Pat. No. 4,946,899 and U.S. Pat. No. 5,260,383. They were developed first of all for biomedical applications and then described in various applications specific to TPSI elastomers, as varied as medical equipment, motor vehicle or domestic electrical appliance parts, sheathings for electric wires, or airtight or elastic parts (see, for example, EP 1 431 343, EP 1 561 783, EP 1 566 405 and WO 2005/103146).

According to a second embodiment, the TPEI elastomers may also comprise a thermoplastic block having a T_{g} (or MP, where appropriate) greater than or equal to 100° C. and formed from polymerized monomers other than styrene monomers (abbreviated to “TPNSI”). Such monomers may be selected from the following compounds and mixtures thereof:
acenaphthylene: a person skilled in the art may, for example, refer to the article by Z. Fodor and J. P. Kennedy, Polymer Bulletin 1992 29(6) 697-705;
indene and its derivatives, such as, for example, 2-methylindene, 3-methylindene, 4-methylindene, dimethylindenes, 2-phenylindene, 3-phenylindene and 4-phenylindene; a person skilled in the art may, for example, refer to the patent document U.S. Pat. No. 4,946,899 by the inventors Kennedy, Puskas, Kaszas and Hager and to the documents J. E. Puskas, G. Kaszas, J. P. Kennedy and W. G. Hager, Journal of Polymer Science, Part A: Polymer Chemistry (1992), 30, 41, and J. P. Kennedy, N. Meguriya and B. Keszler, Macromolecules (1991), 24(25), 6572-6577;
isoprene, then resulting in the formation of a number of trans-1,4-polyisoprene units and of units cyclized according to an intramolecular process; a person skilled in the art may, for example, refer to the documents G. Kaszas, J. E. Puskas and P. Kennedy, Applied Polymer Science (1990), 39(1), 119-144, and J. E. Puskas, G. Kaszas and J. P. Kennedy, Macromolecular Science, Chemistry A28 (1991), 65-80;
esters of acrylic acid, crotonic acid, sorbic acid and methacrylic acid, derivatives of acrylamide, derivatives of methacrylamide, derivatives of acrylonitrile, derivatives of methacrylonitrile and mixtures thereof. Mention may more particularly be made of adamantyl acrylate, adamantyl crotonate, adamantyl sorbate, 4-biphenylyl acrylate, tert-butyl acrylate, cyanomethyl acrylate, 2-cyanoethyl acrylate, 2-cyanobutyl acrylate, 2-cyanohexyl acrylate, 2-cyanoheptyl acrylate, 3,5-dimethyladamantyl acrylate, 3,5-dimethyladamantyl crotonate, isobornyl acrylate, pentachlorobenzyl acrylate, pentafluorobenzyl acrylate, pentachlorophenyl acrylate, pentafluorophenyl acrylate, adamantyl methacrylate, 4-(tert-butyl)cyclohexyl methacrylate, tert-butyl methacrylate, 4-(tert-butyl)phenyl methacrylate, 4-cyanophenyl methacrylate, 4-cyanomethylphenyl methacrylate, cyclohexyl methacrylate, 3,5-dimethyladamantyl methacrylate, dimethylaminoethyl methacrylate, 3,3-dimethylbutyl methacrylate, methacrylic acid, methyl methacrylate, ethyl methacrylate, phenyl methacrylate, isobornyl methacrylate, tetradecyl methacrylate, trimethylsilyl methacrylate, 2,3-xylenyl methacrylate, 2,6-xylenyl methacrylate, acrylamide, N-(sec-butyl)acrylamide, N-(tert-butyl)acrylamide, N,N-diisopropylacrylamide, N-(1-methylbutyl)acrylamide, N-methyl-N-phenylacrylamide, morpholylacrylamide, piperidylacrylamide, N-(tert-butyl)methacrylamide, 4-butoxycarbonylphenylmethacrylamide, 4-carboxyphenylmethacrylamide, 4-methoxycarbonylphenylmethacrylamide, 4-ethoxycarbonylphenylmethacrylamide, butyl cyanoacrylate, methyl chloroacrylate, ethyl chloroacrylate, isopropyl chloroacrylate, isobutyl chloroacrylate, cyclohexyl chloroacrylate, methyl fluoromethacrylate, methyl phenylacrylate, acrylonitrile, methacrylonitrile and mixtures thereof.

According to one variant, the polymerized monomer other than a styrene monomer can be copolymerized with at least one other monomer so as to form a thermoplastic block having a T_{g} or (MP) of greater than or equal to 100° C. According to this aspect, the molar fraction of polymerized monomer other than a styrene monomer, with respect to the total number of units of the thermoplastic block, must be sufficient to achieve a T_{g} (or MP) of greater than or equal to 100° C., preferably of greater than or equal to 130° C., more preferably still of greater than or equal to 150° C., or even of greater than or equal to 200° C. Advantageously, the molar fraction of this other comonomer can range from 0 to 90%, more preferably from 0 to 75% and more preferably still from 0 to 50%.

By way of illustration, this other monomer capable of copolymerizing with the polymerized monomer other than a styrene monomer can be selected from diene monomers, more particularly conjugated diene monomers having from 4 to 14 carbon atoms, and monomers of vinylaromatic type having from 8 to 20 carbon atoms.

When the comonomer is a conjugated diene having from 4 to 14 carbon atoms, it advantageously represents a molar fraction, with respect to the total number of units of the thermoplastic block, ranging from 0 to 25%. Suitable as conjugated dienes which can be used in the thermoplastic blocks according to one subject of the invention are those described above, namely isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or mixtures thereof.

When the comonomer is of vinylaromatic type, it advantageously represents a fraction of units, with regard to the total number of units of the thermoplastic block, from 0 to 90%, preferably ranging from 0 to 75% and more preferably still ranging from 0 to 50%. Suitable in particular as vinylaromatic compounds are the abovementioned styrene monomers, namely methylstyrenes, para-(tert-butyl)styrene, chlorostyrenes, bromostyrenes, fluorostyrenes or else para-hydroxystyrene. Preferably, the comonomer of vinylaromatic type is styrene.

Mention may be made, as illustrative but nonlimiting examples, of mixtures of comonomers, which can be used for the preparation of thermoplastic blocks having a T_{g} greater than or equal to 100° C., composed of indene and of styrene derivatives, in particular para-methylstyrene or para-(tert-butyl)styrene. A person skilled in the art may then refer to the documents: J. E. Puskas, G. Kaszas, J. P. Kennedy and W. G. Hager, Journal of Polymer Science, Part A: Polymer Chemistry, 1992, 30, 41, or J. P. Kennedy, S. Midha and Y. Tsungae, Macromolecules (1993), 26, 429.

Preferably, a TPNSI thermoplastic elastomer is a diblock copolymer: thermoplastic block/isobutylene block. More preferably still, such a TPNSI thermoplastic elastomer is a triblock copolymer: thermoplastic block/isobutylene block/thermoplastic block.

I.1.B.2 Gastight Composition Based on a Thermoplastic Elastomer Containing a Polyisobutylene Block

As an airtight layer or more generally a layer gastight to any inflation gas, use is preferably made of an elastomer composition comprising one or more thermoplastic elastomers containing a polyisobutylene block as described above. The major component of this composition is preferably this or these TPEI(s), that is to say that the composition comprises more than 50 phr (parts per hundred parts of elastomer) of this or these TPEI(s).

The gastight layer described above could optionally comprise elastomers other than the TPEI(s), preferably in a minor amount (less than 50 phr). Such additional elastomers could be, for example, diene elastomers such as natural rubber or a synthetic polyisoprene, a butyl rubber or even other saturated styrene thermoplastic elastomers, within the limit of the compatibility of their microstructures. In such a case and preferably, the content of TPEI elastomer in the airtight composition is greater than 70 phr, in particular within a range from 80 to 100 phr.

However, according to one particularly preferred embodiment, the TPEI(s), in particular SIB or SIBS, are the only thermoplastic elastomers, and more generally the only elastomers present in the gastight layer; consequently, in such a case, their content is equal to 100 phr.

The TPEI described above, in particular SIB or SIBS, is sufficient by itself, in the elastomer layer, for the function of gastightness with respect to the pneumatic tyres in which they are used to be fulfilled.

However, it is possible to combine with this TPEI, as plasticizing agent, an extender oil (or plasticizing oil), the role of which is to facilitate the processing, particularly the incorporation into a pneumatic article via a reduction of the modulus and an increase of the tackifying power of the gastight layer.

Any extender oil may be used, preferably one having a weakly polar nature, capable of extending or plasticizing elastomers, especially thermoplastic elastomers.

At ambient temperature (23° C.), these oils, which are more or less viscous, are liquids (i.e. as a reminder, substances having the ability to eventually adopt the shape of their container), as opposed especially to resins which are solids by nature.

Preferably, the extender oil is selected from the group consisting of polyolefin oils (i.e. those resulting from the polymerization of olefins, monoolefins or diolefins), paraffinic oils, naphthenic oils (of low or high viscosity), aromatic oils, mineral oils and mixtures of these oils.

Use is preferably made of polybutene oils, particularly polyisobutylene (abbreviated to “PIB”) oils, which have demonstrated the best compromise of properties compared with the other oils tested, especially with oils of paraffinic type.

As examples, polyisobutylene oils are sold in particular by UNIVAR under the name “Dynapak Poly” (e.g. “Dynapak Poly 190”), by BASF under the names “Glissopal” (e.g. “Glissopal 1000”) or “Oppanol” (e.g. “Oppanol B12”) and by INEOS Oligomer under the name “Indopol H1200”. Paraffinic oils are sold, for example, by Exxon under the name “Telura 618” or by Repsol under the name “Extensol 51”.

The number-average molecular weight (denoted by Mₙ) of the extender oil is preferably between 200 and 25 000 g/mol, more preferably still between 300 and 10 000 g/mol. For excessively low Mₙ weights, there is a risk of the oil migrating to the outside of the composition, whereas excessively high weights may result in this composition becoming too stiff. An Mₙ weight between 350 and 4000 g/mol, in particular between 400 and 3000 g/mol, proves to constitute an excellent compromise for the intended applications, in particular for use in a pneumatic tyre.

The number-average molecular weight (denoted by Mₙ) of the extender oil is determined by SEC, the sample being dissolved beforehand in tetrahydrofuran at a concentration of approximately 1 g/1; the solution is then filtered through a filter with a porosity of 0.45 μm before injection. The equipment is a “Waters alliance” chromatographic chain. The elution solvent is tetrahydrofuran, the flow rate is 1 ml/min, the temperature of the system is 35° C. and the analysis time is 30 min. A set of two Waters columns with the name “Styragel HT6E” is used. The injected volume of the solution of the polymer sample is 100 μl. The detector is a “Waters 2410” differential refractometer and its associated software for handling the chromatographic data is the “Waters Millenium” system. The calculated average molecular weights are relative to a calibration curve produced with polystyrene standards.

A person skilled in the art will know, in light of the description and the exemplary embodiments that follow, how to adjust the amount of extender oil as a function of the particular usage conditions of the gastight elastomer layer, in particular of the pneumatic tyre in which it is intended to be used.

If an extender oil is used, it is preferred that its extender content be greater than 5 phr, in particular between 5 and 100 phr. Below the minimum indicated, the gastight layer risks having too high a stiffness for certain applications, whereas beyond the recommended maximum, there is a risk of insufficient cohesion of the gastight layer and of loss of gastightness that may be detrimental depending on the application considered.

For these reasons, in particular for a use of the airtight layer in a pneumatic tyre, it is preferred that the extender oil content be greater than 10 phr, in particular between 10 and 90 phr, more preferably still that it be greater than 20 phr, in particular between 20 and 80 phr.

The gastight layer may also comprise platy fillers.

The use of platy filler advantageously makes it possible to lower the permeability coefficient (and thus to increase the airtightness) of the elastomer composition without excessively increasing its modulus, which makes it possible to retain the ease of incorporation of the airtight layer in the pneumatic article.

“Platy” fillers are well known to a person skilled in the art. They have been used in particular in pneumatic tyres to reduce the permeability of conventional gastight layers based on butyl rubber. They are generally used in these butyl-based layers at relatively low contents not usually exceeding from 10 to 15 phr (see, for example, the patent documents US 2004/0194863 and WO 2006/047509). They have also been used in TPEI-based airtight layers, see documents WO 2009/007064 and WO 2011/012529.

They are generally provided in the form of stacked plates, platelets, sheets or lamellae, with a more or less marked anisometry. Their aspect ratio (A=L/T) is generally greater than 3, more often greater than 5 or than 10, L representing the length (or greatest dimension) and T representing the average thickness of these platy fillers, these averages being calculated as number averages. Aspect ratios reaching several tens, indeed even several hundreds, are common. Their average length is preferably greater than 1 μm (that is to say that “micrometre-sized” platy fillers are then involved), typically between several μm (for example 5 μm) and several hundred μm (for example 500 μm, indeed even 800 μm).

Preferably, the platy fillers used in accordance with the invention are selected from the group consisting of graphites, phyllosilicates and the mixtures of such fillers. Mention will in particular be made, among phyllosilicates, of clays, talcs, micas or kaolins, it being possible for these phyllosilicates to be unmodified or to be modified, for example by a surface treatment; mention may in particular be made, as examples of such modified phyllosilicates, of micas covered with titanium oxide or clays modified by surfactants (“organo clays”).

Use is preferably made of platy fillers having a low surface energy, that is to say which are relatively apolar, such as those selected from the group consisting of graphites, talcs, micas and the mixtures of such fillers, it being possible for the latter to be modified or unmodified, more preferably still selected from the group consisting of graphites, talcs and the mixtures of such fillers. Mention may in particular be made, among graphites, of natural graphites, expanded graphites or synthetic graphites.

Mention may be made, as examples of micas, of the micas sold by CMMP (Mica-MU®, Mica-Soft® and Briomica®, for example), those sold by Yamaguchi (A51S, A41S, SYA-21R, SYA-21RS, A21S and SYA-41R), vermiculites (in particular the Shawatec® vermiculite sold by CMMP or the Microlite® vermiculite sold by W.R. Grace) or modified or treated micas (for example, the Iriodin® range sold by Merck). Mention may be made, as examples of graphites, of the graphites sold by Timcal (Timrex® range). Mention may be made, as examples of talcs, of the talcs sold by Luzenac.

The platy fillers described above may be used at variable contents, in particular between 2% and 30% by volume and preferably between 3% and 20% by volume of elastomer composition.

The introduction of the platy fillers into the TPEI may be carried out according to various known processes, for example by solution mixing, by bulk mixing in an internal mixer or by extrusion mixing.

The airtight layer may also comprise various additives, in particular those usually present in the airtight layers and/or the adhesive layers known to a person skilled in the art, for example reinforcing fillers such as carbon black or silica, non-reinforcing or inert fillers, plasticizers other than those mentioned above, protecting agents such as antioxidants or antiozonants, UV stabilizers, colouring agents that can advantageously be used for colouring the compositions, various processing aids or other stabilizers.

The airtight layer described is a compound that is solid (at 23° C.) and elastic, which is characterized in particular, owing to its specific formulation, by a very high flexibility and very high deformability. In particular, according to one preferred embodiment, the airtight layer has a secant modulus in extension, at 10% elongation, which is less than 2 MPa, more preferably less than 1.5 MPa (in particular less than 1 MPa). This quantity is measured at first elongation (i.e. without an accommodation cycle) at a temperature of 23° C., with a pull rate of 500 mm/min (ASTM D412 standard), and normalized to the initial cross section of the test specimen.

Preferably, the airtight layer described above has a thickness of greater than 0.05 mm, more preferably between 0.1 and 10 mm (for example from 0.2 to 2 mm).

It will be easily understood that, depending on the specific fields of application, the dimensions and the pressures involved, the embodiment of the invention may vary, the first airtight layer in fact having several preferred thickness ranges. Thus, for example, for pneumatic tyres of passenger vehicle type, they may have a thickness of at least 0.3 mm, preferably of between 0.5 and 2 mm. According to another example, for pneumatic tyres for heavy-duty or agricultural vehicles, the preferred thickness may be between 1 and 3 mm. According to another example, for pneumatic tyres for vehicles in the civil engineering field or for aircraft, the preferred thickness may be between 2 and 10 mm.

### I-2. Deformable Fibre Assembly

An essential element of the adhesion layer according to one aspect of the invention is to be formed of a deformable fibre assembly.

The expression “fibre assembly” is understood to mean any manufactured product consisting of a web, a lap or a mat of fibres, whether they are distributed directionally or randomly, and the fibres of which are entangled or interlaced two-dimensionally or three-dimensionally for the nonwoven fabrics, or woven for the woven fabrics. By extension, laps or mats of fibres produced by spraying short fibres, for example, are also included.

The expression “deformable fibre assembly” is understood to mean any fibre assembly in which the fibres may easily slide with respect to one another and consequently which withstand significant deformation without tearing and that only put up weak to resistance in at least one direction.

The fibres may be filaments, monofilaments or multifilament assemblies.

The methods of manufacturing such woven or nonwoven fibre assemblies are well known, in particular by needlepunching or fulling for assemblies such as felts.

The presence of this woven or nonwoven deformable fibre assembly makes it possible to create, during the curing of the pneumatic tyre, a significant adhesion between the gastight layer and the adjacent rubber compound via impregnation of the deformable fibre assembly by these two compositions carried out during curing under high pressure and at high temperature.

Of course, the fibre assembly must be put in place during the manufacture of the pneumatic tyre so that the deformability of the assembly in the circumferential direction is sufficient to allow the shaping but also the deformations under running conditions of the pneumatic tyre.

According to a first embodiment, the deformable fibre assembly is a nonwoven fabric.

The fibres of such a nonwoven assembly must not be rigidly bonded to one another in order to give the fibre assembly the ability to follow the shaping of the pneumatic tyre during its manufacture. Thus, the nonwoven fabrics in accordance with one subject of the invention do not comprise an adhesion product or binder usually intended to consolidate the nonwoven web or mat.

An example of such a nonwoven assembly is sold by PGI with the reference NLC10-501. The fibres are made of polyester and the nonwoven fabric has a thickness of 0.3 mm and a basis weight of 50 g/m².

According to a second embodiment, the deformable fibre assembly is a woven fabric, the extensibility of which in at least one direction is greater than 60%, and preferably greater than 100%.

The extensibility of such woven fabrics enables the assembly to follow the shaping of the pneumatic tyre during its manufacture. This extensibility may be linked to the technique for assembling the fibres, for example by knitting, or else to the method of to producing the fibres themselves in order to render them elastic.

An example of an elastic woven fabric is the knit fabric sold by Milliken under the reference 2700 composed of 82% of polyamide 6 fibres and of 18% of 44 dTex polyurethane.

According to a third embodiment, the deformable fibre assembly is a two-dimensional mat of short fibres, obtained for example by spraying short fibres, i.e. fibres whose length is between several millimetres and several centimetres. The fibres are not bonded to one another and such an assembly exerts practically no return force in the event of deformation.

Preferably, the ratio between the length and the diameter of the fibres of the deformable assembly is greater than 20 and very preferably greater than 50, or else greater than 100.

The fibres of the deformable fibre assembly may be selected from textile fibres of natural origin, for example from the group of silk, cotton, bamboo, cellulose and wool fibres and mixtures thereof.

Examples of wool fibre assemblies are the “PLB” and “MLB” felts from Laoureux.

The fibres of the deformable fibre assembly may also be selected from the group of synthetic textile fibres, for example polyester, polyamide, carbon, aramid, polyethylene, polypropylene, polyacrylonitrile, polyimide, polysulphone, polyether sulphone, polyurethane, polyvinyl alcohol fibres and mixtures thereof.

The fibre assemblies may equally well be composed of several types of fibres from one and the same group or from different groups as described above.

Preferably, the weight per unit of area or basis weight of the deformable fibre assembly before impregnation of an elastomer material is greater than 1 g/m², more preferably greater than 10 g/m² and more preferably still between 20 and 120 g/m².

Such a low basis weight of the deformable fibre assembly makes it possible to obtain an excellent impregnation by the adjacent elastomer materials under pressure and at high temperature.

Preferably, the thickness of the deformable fibre assembly before its impregnation is less than 1 millimetre, preferably less than 500 micrometres and very preferably less than 200 micrometres. This facilitates a good impregnation of the fibres by the adjacent elastomers. This impregnation takes place during the vulcanization of the pneumatic tyre at a temperature above 150° C. and at a pressure of greater than 10 bar. This ensures an excellent impregnation of the adjacent elastomer materials without leaving voids.

### II. EXEMPLARY EMBODIMENT OF THE INVENTION

The gastight layer with adhesion layer according to one subject of the invention can advantageously be used in pneumatic tyres for all types of vehicles, in particular the tyres for passenger vehicles capable of running at very high speed or the tyres for industrial vehicles, such as heavy-duty vehicles.

By way of example, the single appended FIGURE represents, highly schematically (not to a specific scale), a radial cross section of a pneumatic tyre in accordance with the invention intended for a passenger-type vehicle.

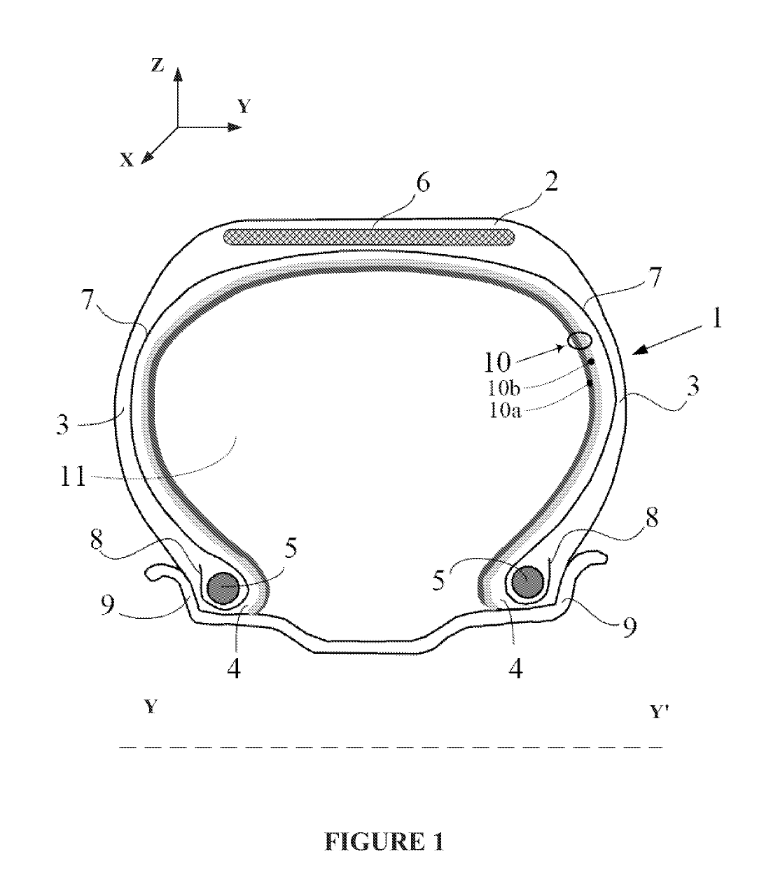

This FIG. 1 comprises an orthogonal marker, Y corresponds to the axial direction, with reference to the axis of rotation of the pneumatic tyre, YY′, Z corresponds to the radial direction, from the axis of rotation to the crown of the pneumatic tyre and X corresponds to the longitudinal or circumferential direction. At any point, X is normal to the directions Y and Z.

This pneumatic tyre 1 comprises a crown 2 reinforced by a crown reinforcement or belt 6, two sidewalls 3 and two beads 4, each of these beads 4 being reinforced with a bead wire 5. The crown 2 is surmounted by a tread not represented in this schematic FIGURE. A carcass reinforcement 7 is wound around the two bead wires 5 in each bead 4, the turn-up 8 of this reinforcement 7 being, for example, positioned towards the outside of the tyre 1, which is here represented fitted on its rim 9. The carcass reinforcement 7 is, in a way known per se, composed of at least one ply reinforced by “radial” cords, for example textile or metal cords, that is to say that these cords are positioned virtually parallel to one another and extend from one bead to the other, so as to form an angle of between 80° and 90° with the median circumferential plane (plane perpendicular to the axis of rotation of the tyre which is situated at mid-distance from the two beads 4 and passes through the middle of the crown reinforcement 6).

The pneumatic tyre 1 is such that its inner wall comprises a multilayer laminate (10) comprising at least two layers (10a, 10b), that is airtight owing to its first layer (10a) positioned on the side of the internal cavity 11, and adhesive with respect to the rest of the structure of the tyre (for example its carcass reinforcement) owing to its radially outermost adhesion layer (10b). This adhesion layer consists of a deformable fibre assembly, so as to be able to withstand the shaping of the pneumatic tyre and also the deformations under running conditions. If the fibre assembly has a preferred deformability direction, the assembly must be positioned in the pneumatic tyre so that this preferred direction is oriented circumferentially. In accordance with one preferred embodiment of the invention, the two layers (10a, 10b) cover substantially the entire inner wall of the pneumatic tyre, extending from one sidewall to the other, at least up to the level of the rim gutter when the pneumatic tyre is in the fitted position.

In this example, the layer 10a (having a thickness of 0.75 mm approximately) comprises an SIBS elastomer (“Sibstar 102T” with a styrene content of around 15%, a T_{g} of around −65° C. and an average molecular weight Mₙ of around 90 000 g/mol), 28 phr (i.e. 5% by volume of the first layer) of a platy filler (“Mica-Soft 15”) and a polyisobutylene extender oil (“Indopol H1200”) at a weight content of around 65 phr.

The layer 10a was prepared as follows. The three constituents (SIBS, platy filler and oil) were mixed in a conventional manner, using a twin-screw extruder (L/D=40), at a temperature typically above the melting point of the composition (around 190° C.). The extruder used had a first feed (hopper) for the SIBS, a second feed (hopper) for the platy filler and finally a pressurized liquid injection pump for the polyisobutylene extender oil; it was provided with a die that makes it possible to extrude the product to the desired dimensions. The gastight layer was extruded at a temperature of 220° C.

The adhesion layer 10b was itself a deformable fibre assembly consisting of a nonwoven polyester fabric with a thickness of 0.3 mm and a basis weight of 50 g/m² of reference NLC10-501 sold by PGI.

Such a two-layer laminate as described above may easily be produced by extrusion of the gastight layer directly onto the deformable fibre assembly. This thus leads to a partial impregnation of the deformable fibre assembly by the gastight layer. The laminate is then used as a semi-finished product during the production of the tyre.

Another embodiment of a two-layer laminate as described above consists in spraying short fibres onto a profiled element of the airtight layer in order to form a deformable fibre mat or assembly.

The tyre provided with its multilayer laminate (10) as described above is assembled before vulcanization (or curing).

In a first embodiment, the two-layer laminate is simply applied in one go, in a conventional manner, at the desired location; the vulcanization is then carried out conventionally at a set temperature of the order of 180° C. and a pressure of 15 bar in the case of pneumatic tyres for passenger vehicles. The temperatures and pressures may be higher or lower for producing pneumatic tyres of different dimensions.

One possible manufacturing variant, for a person skilled in the art of pneumatic tyres, will consist for example during a first step, in laying down flat the airtight layer (10a) directly on a tyre-building drum then the adhesion layer (10b), in the form of two layers of suitable thicknesses, before covering the laminate thus formed with the remainder of the structure of the pneumatic tyre in the uncured state, according to manufacturing techniques well known to a person skilled in the art.

It was observed that the chosen deformable fibre assembly, of reference NLC10-501, put in place as described above on a tyre-building drum on top of the gastight layer was then subjected, without difficulty, to the stresses linked to the shaping and then the vulcanization of the pneumatic tyre.

### II-1. Tests

The adhesion and airtightness properties of the laminate according to the invention are characterized as indicated below.

In order to characterize the airtightness of the laminate, use was made of a rigid-wall permeameter, placed in an oven (temperature at 60° C. in the present case), equipped with a pressure sensor (calibrated in the range from 0 to 6 bar) and connected to a tube equipped with an inflation valve. The permeameter can receive standard test specimens in disc form (for example, with a diameter of 65 mm in the present case) and with a uniform thickness which can range up to 3 mm (0.5 mm in the present case). The pressure sensor is connected to a National Instruments data acquisition card (0-10 V analogue four-channel acquisition) which is connected to a computer carrying out continuous acquisition with a frequency of 0.5 Hz (1 point every two seconds). The permeability coefficient (K) is measured from the linear regression line (average of 1000 points) giving the slope α of the pressure loss through the test specimen tested as a function of the time, after stabilization of the system, that is to say the achievement of stable conditions under which the pressure decreases linearly as a function of the time.

Adhesion tests (peel tests) were also carried out in order to test the ability of the gastight layer to adhere after curing to a diene elastomer layer, more specifically to a standard rubber composition for a pneumatic tyre carcass reinforcement, based on (peptized) natural rubber and carbon black N330 (65 parts by weight per hundred parts of natural rubber), also comprising the standard additives (sulphur, accelerator, ZnO, stearic acid, antioxidant).

The peel test specimens (of 180° peel type) were produced by stacking a thin layer of gastight composition with and without a deformable fibre assembly between two calendered fabrics, the first with an SIBS elastomer (1.5 mm) and the other with the diene blend under consideration (1.2 mm). An incipient crack is inserted between the two calendered fabrics at the end of the thin layer.

The test specimen, after assembly, was vulcanized at 180° C. under pressure of 15 bar for 10 minutes. These conditions are representative of the curing of a pneumatic tyre. Strips with a width of 30 mm were cut out using a cutting machine. The two sides of the incipient crack was subsequently placed in the jaws of an Instron® tensile testing machine. The tests are carried out at ambient temperature and at a rate of 100 mm/min. The tensile stresses are recorded and are standardized with respect to the width of the test specimen. A curve of force per unit of width (in N/mm) as a function of the mobile crosshead displacement of the tensile testing machine (between 0 and 200 mm) is obtained. The adhesion value selected corresponds to the initiation of failure within the test specimen and therefore to the maximum value of this curve.

### II-2. Experimental Tests

A gastight composition containing an SIBS elastomer (having the composition indicated above) was prepared as described above. Two types of test specimens for the peel tests and airtightness tests were produced; the first E-1 comprises only one airtight layer between the two calendered fabrics, the second E-2 additionally comprises a deformable fibre assembly (polyester nonwoven of reference NLC10-501 from PGI) positioned between the airtight layer and the natural rubber-based calendering of the calendered fabric.

Table 1 gives the results of the tests taking the value 100 for the E-1 test specimens.

TABLE 1

| Test specimens | E-1 | E-2 |
|---|---|---|
| Maximum peel force | 100 | 650 |
| Airtightness performance | 100 | 152 |

It was observed that the use of the adhesive layer based on a deformable fibre assembly made it possible to greatly improve, by a factor of more than five, or even more in many cases, the adhesion between the gastight layer and the natural rubber composition.

It is thus observed that the presence of the deformable fibre assembly also makes it possible to significantly improve the airtightness performance of the laminate.

1.-28. (canceled)

29. A pneumatic tire comprising:
a crown with an outer rubber tread and a crown reinforcement,
a carcass reinforcement,
a gastight layer positioned internally relative to the carcass reinforcement, and an adhesion layer adjacent to the gastight layer and positioned between the carcass reinforcement and the gastight layer,
wherein the adhesion layer consists of a deformable fibre assembly.

30. The pneumatic tire according to claim 29, wherein fibres of the deformable fibre assembly have a ratio between fibre length and fibre diameter of greater than 20.

31. The pneumatic tire according to claim 30, wherein the ratio is greater than 100.

32. The pneumatic tire according to claim 29, wherein the deformable fibre assembly is a two-dimensional assembly.

33. The pneumatic tire according to claim 29, wherein the deformable fibre assembly is a nonwoven fabric.

34. The pneumatic tire according to claim 29, wherein the deformable fibre assembly consists of a two-dimensional stack of short fibres.

35. The pneumatic tire according to claim 29, wherein the deformable fibre assembly is a woven fabric, the extensibility of which in at least the circumferential direction of the pneumatic tire is greater than 60%.

36. The pneumatic tire according to claim 35, wherein the extensibility is greater than 100%.

37. The pneumatic tire according to claim 29, wherein fibres of the deformable fibre assembly are selected from the group consisting of natural textile fibres, synthetic textile fibres and mixtures thereof.

38. The pneumatic tire according to claim 37, wherein the fibres comprise fibres selected from the group consisting of silk, cotton and wool fibres.

39. The pneumatic tire according to claim 37, wherein the fibres comprise fibres selected from the group consisting of cellulose, polyamide, aramid, polyethylene, polypropylene, polyacrylonitrile, polyimide, polysulphone, polyether sulphone, polyurethane, polyvinyl alcohol, polyester and polyvinyl chloride fibres.

40. The pneumatic tire according to claim 29, wherein the deformable fibre assembly has a basis weight of greater than 1 g/m².

41. The pneumatic tire according to claim 40, wherein the basis weight is greater than 10 g/m².

42. The pneumatic tire according to claim 41, wherein the basis weight is between 20 and 120 g/m².

43. The pneumatic tire according to claim 29, wherein the deformable fibre assembly has a thickness of less than 1 mm.

44. The pneumatic tire according to claim 43, wherein the thickness is less than 500 μm.

45. The pneumatic tire according to claim 44, wherein the thickness is less than 200 μm.

46. The pneumatic tire according to claim 29, wherein the gastight layer is based on a thermoplastic elastomer containing a polyisobutylene block and a thermoplastic block.

47. The pneumatic tire according to claim 46, wherein the thermoplastic block has a glass transition temperature or a melting point above 100° C.

48. The pneumatic tire according to claim 47, wherein the thermoplastic block consists of at least one polymerized styrene monomer.

49. The pneumatic tire according to claim 48, wherein the thermoplastic block comprises at least one polystyrene block.

50. The pneumatic tire according to claim 49, wherein the thermoplastic elastomer containing the polyisobutylene block and the thermoplastic block is selected from the group consisting of styrene/isobutylene copolymers, styrene/isobutylene/styrene copolymers, and mixtures thereof.

51. The pneumatic tire according to claim 29, wherein the gastight layer is based on a butyl rubber.

52. A process for manufacturing a pneumatic tire comprising a crown with an outer rubber tread and a crown reinforcement, a carcass reinforcement and a radially internal gastight layer relative to the carcass reinforcement, the process comprising the steps of:
incorporating into the pneumatic tire, during the manufacture thereof, an adhesion layer adjacent to the gastight layer and positioned between the carcass reinforcement and the gastight layer, the adhesion layer consisting of a deformable fibre assembly; and then
vulcanizing the pneumatic tire under pressure and at high temperature.

53. The process according to claim 52, wherein, after having deposited the gastight layer flat on a tire-building drum, the deformable fibre assembly is placed on this drum.

54. The process according to claim 52, wherein, before depositing the gastight layer flat on a tire-building drum, a deformable fibre assembly is deposited on the gastight layer in order to form a laminate.

55. The process according to claim 54, wherein short fibres are sprayed onto a profiled element of the gastight layer in order to form a deformable fibre assembly.

56. The process according to claim 52, wherein, before depositing the gastight layer flat on a tire-building drum, the gastight layer is extruded onto a deformable fibre assembly in order to form a laminate.

57. The process according to claim 52, wherein the vulcanization temperature is above 150° C. and the vulcanization pressure is greater than 10 bar.
